(19) United States
(12) Patent Application Publication
(10) Pub. No.: US 2005/0086861 A1
(43) Pub. Date: Apr. 28, 2005

(54) Adaptable plant root development container

(76) Inventor: Frederic P. Atchley, Apopka, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/691,183

(22) Filed: Oct. 22, 2003

(51) Int. Cl. A01G 9/02

(52) U.S. Cl. 47/65.5

(57) ABSTRACT

A plant growing apparatus, the apparatus comprising a sidewall with an outer surface and an inner surface and having a plurality of tiers where each descending tier has a smaller diameter than the tier immediately above, an anti-circling channel formed in the sidewall wherein the channel protrudes through the sidewall forming an indenture in the inner surface of the sidewall and a channel on the outer surface of the sidewall, a plurality of slots formed therethrough the sidewall, and a detachable base that is connected to the sidewall.

### BACKGROUND OF THE INVENTION

This invention relates to a plant container, and more particularly, to an air root prune anti-circling container with a removable base configurable to best work in a given environment.

Typically a plant, such as a tree, is grown from seed or a cutting from an existing plant. This seed or cutting is usually placed in a small container and covered with soil or some other top covering. Once mature enough, the plant is moved into a larger sized container to continue the development process. A larger container is used to better accommodate the plant's root development, since more room may be needed as the plant grows. Plants with a weak root system or plants that are not likely to develop into a plant that is acceptable based on industry grades and standards established whether a plant is acceptable for resale, are usually destroyed.

A common problem experienced by commercial ornamental horticultural nurseries is circling and kinking of the root system due to the plant developing its root system in a container not designed to reduce the chances for the roots to circle and/or kink. One form of kinking is when a taproot reaches the base of a container and then curves upward, thus forming a “J” root. This “J” root could kill a plant.

Another issue faced by nurseries is insuring that plants grow as vertical as possible. This becomes a more significant issue when nurseries are established on ground that is not level. When this occurs, a container may be placed on a section of ground where the container is not level and thus the plant may grow at an angle within the container. This could be a bad result if the trunk of the plant starts growing in one direction based on the topography of a patch of ground in a nursery and then changes direction if the plant is repositioned on another patch of ground with different topography.

The direction a plant's roots grow is particularly important. Tree roots are established early and do not change direction once they are established. Tree roots generally grow out from the center of the tree and down to the depth of the environment provided for the roots to grow. The more roots developed, the healthier the circulatory system and ability to uptake nutrients and moisture. The goal in growing the tree is to develop as many fibrous, hair-like roots as possible before the tree reaches a 1 to 2 inch caliper size. Additionally, the fibrous roots should be well branched and as straight as possible for a successful transplant into the next container size or a landscape project.

One approach, known in the prior art, to stop the formation of “J” roots is the use of air-root pruning. Air-root pruning is where the ends of a root are exposed to air. Typically, a plurality of openings are formed through the container's side wall or walls and/or base. Another issue faced by some nurseries involves the composition of the ground upon which containers are placed while plants develop. Since containers are placed out in the elements, experiencing varying weather conditions, the ground may impede container opening provided for air-root pruning that are closest to the ground. This may occur when the ground is composed primarily of sand or of a soil texture that turns to mud after experiencing a given amount of precipitation. Thus, the air pruning that was to have occurred closer to the base of the container may not be possible if the openings are clogged by mud or shifting sand.

Currently nurseries are located where the ground is nearly flat in nature. Not having adequate terrain results in having to transport plants a greater distance because level enough land is not available in certain geographic areas. Transporting plants adds to the cost of the plant once finally sold.

In view of these issues, plant growers would benefit from a growing container that is able to provide for pruning plant roots while also being able to optimally function in various environmental conditions.

### BRIEF DESCRIPTION OF THE INVENTION

Towards this end, the present invention is directed to an apparatus and method for improving root development of a plant. In a preferred embodiment, a plant growing apparatus is disclosed having a sidewall. The sidewall has an outer surface and an inner surface, and also has a plurality of tiers where each descending tier has a smaller diameter than the tier immediately above. A ledge is formed in an inside of the sidewall where adjacent tiers meet. An anti-circling channel is formed in the sidewall. The channel protrudes through the sidewall forming an indenture in the inner surface of the sidewall and a channel on the outer surface of the sidewall. A plurality of slots is formed therethrough the sidewall. A detachable base is provided that is connected to the sidewall.

Functionally, a method of air pruning and controlling root growth in a plant is disclosed. A container with a sidewall that has a plurality of tiers where each descending tier has a smaller diameter than the tier immediately above is disclosed. A root is prevented from circling by way of an anti-circling channel extending upwardly along an inner surface of the sidewall. A root is pruned by air entering through slots disposed therethrough the sidewall of the container. The container is elevated with a detachable base to allow air-root pruning to occur without interference from a ground covering.

In another embodiment an improvement to a growing container that has anti-circling channels and air-root pruning openings is disclosed. The improvement is a detachable base having a top end and a lower end wherein the base elevates the container allowing the air-root pruning openings to be free of obstructions caused by a ground that the container sits upon.

### BRIEF DESCRIPTION OF THE DRAWINGS

The features of the invention are set forth with particularity in the appended claims. The invention itself, both as to organization and method of operation, may best be understood by reference to the following description, in conjunction with the accompanying drawings, in which like numbers represent like parts throughout the drawings, and in which:

FIG. 1 is an exemplary embodiment of an elevational view of a preferred embodiment of the present invention;

FIG. 2 is an exemplary embodiment of a side view of a preferred embodiment of the present invention;

FIG. 3 is an exemplary embodiment of a top view of a preferred embodiment of the present invention;

FIG. 4 is an exemplary embodiment of a side view of a preferred embodiment of the present invention;

FIG. 5 is an exemplary embodiment of a top view of a removable base, as illustrated in FIGS. 1, 2, and 4;

FIG. 6 is an exemplary embodiment of a side view of a preferred embodiment of the present invention; and

FIG. 7 is an exemplary embodiment of a preferred embodiment of the present invention with a section removed from a base to further illustrate the internal aspects of the base.

### DETAILED DESCRIPTION OF THE INVENTION

With reference to the figures, exemplary embodiments of the invention will now be described. The scope of the invention disclosed is applicable to a plurality of containers used for growing and transporting plants, such as trees. Thus, even though embodiments are described specific to circular containers, one skilled in the art will recognize how the invention is also applicable to other shaped containers used for growing plants.

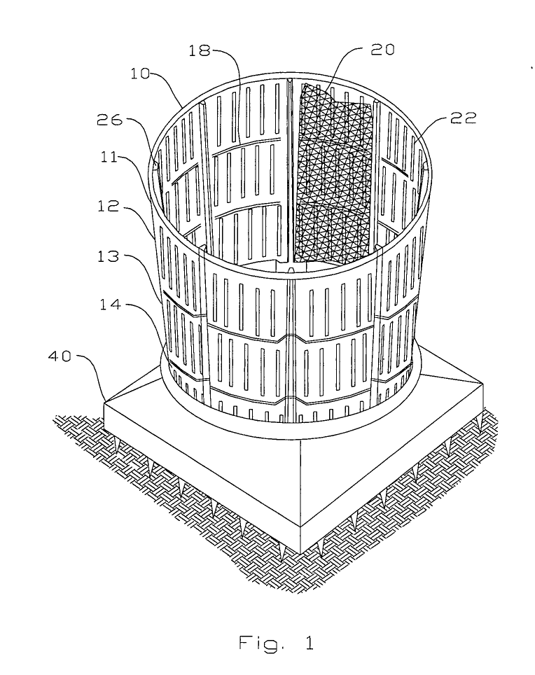

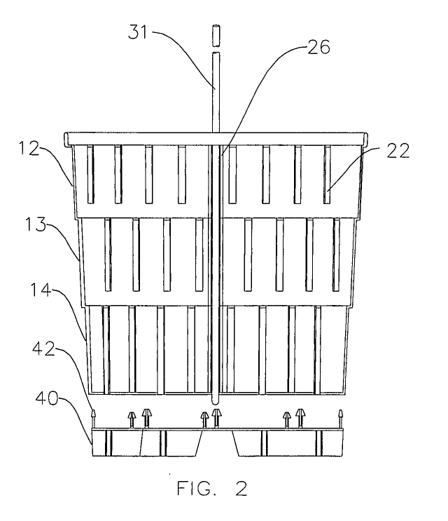

FIG. 1 is an exemplary embodiment of an elevational view of a preferred embodiment of the present invention and FIG. 2 is an exemplary embodiment of a side view of a preferred embodiment of the present invention. In a preferred embodiment, the sidewall 11 of the container 10 is composed of several segments, or tiers 12, 13, 14, such as three tiers. Beginning with the bottom tier 14 or the tier closest to the ground, each ascending tier has a slightly larger diameter than the tier immediately below it. Within the wall 11 created by the tiers 12, 13, 14, an offset, interior ledge 18 is formed where each tier meets.

The sidewall 11 is nearly vertical and a natural fiber cover or bag, such as coconut fiber, coir, wall insert 20 may be placed within the sidewall 11. The natural fiber inset 20 holds the soil and root system while also allowing roots to penetrate completely through the coir material into an air slot. The natural fiber insert 20 assists in reducing root circling and can be left around the root ball when the plant is transplanted from the container 10 and into a final landscape.

Slots 22, otherwise known as air prune slots, openings, or holes, are formed therethrough the sidewall 11 of each offset tier 12, 13, 14. The air-root pruning openings 22 are provided to allow air to enter into the container 10 to begin hardening the ends or tips of a plant's root system closest to the openings. In one preferred embodiment, the openings 22 are spaced an equal distance from adjacent openings. Depending upon the predetermined growing pattern of a plant's root system, the size of the openings 22 may be varied tier to tier. For example, if a plant has a root system that typically grows near the soil surface the plant is placed within, the container 10 may be formed with openings 22 in the top tier 12 that are larger in size, such as a third size larger, than the openings in the lower tiers 13, 14. In addition to having the openings 22 varied tier-to-tier, the openings 22 may also be varied within a common tier as well.

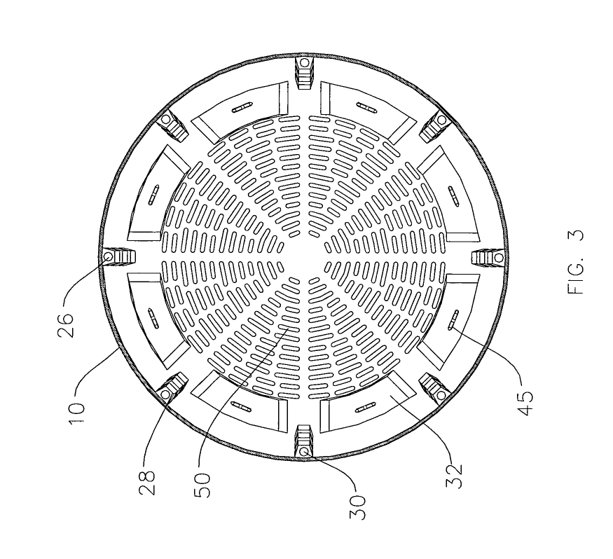

A plurality of sidewall anti-circling channels 26 are also formed in the container wall 11. These channels 26 extend from the top tier 12, through any middle tiers 13, and down through the bottom tier 14. The anti-circling channels 26 are formed so that a distinct indenture 28 is created within the interior wall of the container 10, as better illustrated in FIG. 3. Both vertical ends of the anti-circling channels have open areas, or holes 30. Instead of including a rim with holes to stake the container 10 to a ground surface, the stakes 31 may be inserted through the holes 30 in the anti-circling channels 26, then into the ground upon which the container 10 is placed.

As further illustrated in FIG. 3, the lowest tier 14 has an opening at the end furthest from the top tier 12. In a preferred embodiment, an edge, or lip 32 extends from the lowest tier 14 towards the center of the container 10. A removable base 40, as illustrated in FIG. 2, may be connected to the bottom end of the lowest tier 14. In a preferred embodiment, rounded cleats 42, such as split arrowheads, extend from the base 40 upwards towards the lowest tier 14. One skilled in the art will readily recognize that other mechanical connections are possible wherein the lowest tier 14 does not require a lip 32, such as, but not limited to, exterior clamps, a threaded connection to allow the lowest tier 14 and base 40 to connect, or other forms of locking connectors. As further illustrated in FIG. 3, on the edge of the lowest tier 14, openings 45 are provided through the edge 32 to accept the split arrowheads 42. The openings 45 also perform another function of removing moisture by allowing accumulated moisture to pass through the holes 45 and away from the root system. In another preferred embodiment, the container 10 has a closed end located in the lowest tier 14 where the lip 32 extends from the bottom tier, as illustrated in FIG. 3, and has a mesh-like, or honeycomb bottom 50. The base 40 then connects to the lowest tier 14 as disclosed above.

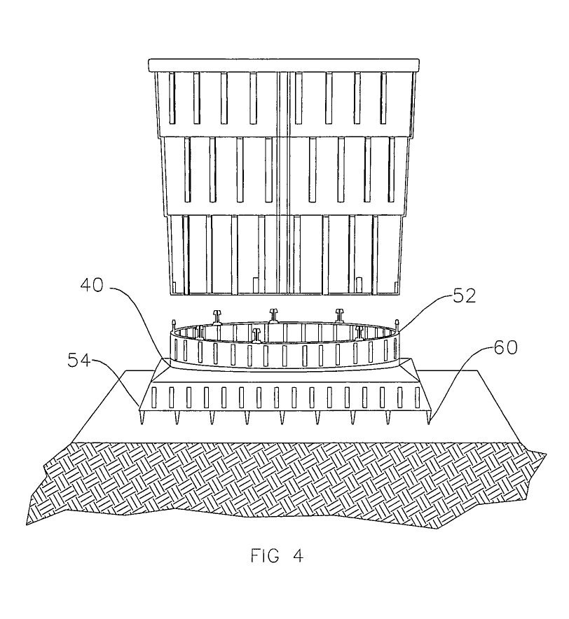

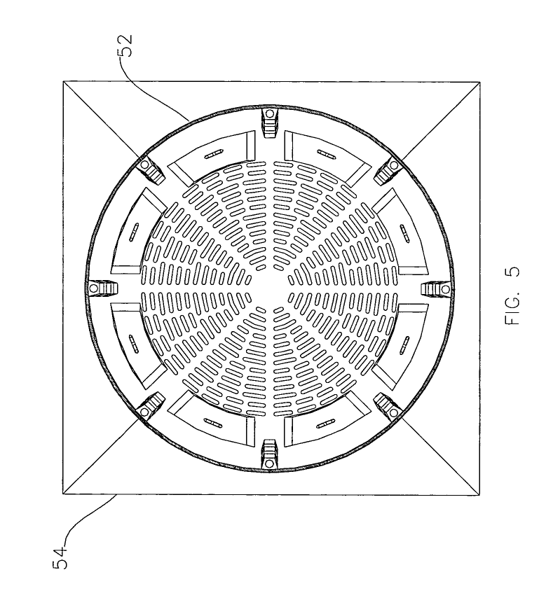

In operation, the container 10 can be used with or without the base 40. If a need for the base 40 arises, such as if the soil upon which the container 10 sits is prone to clog air-root pruning openings or the ground is not level, the base 40 can be attached. The base 40 may have a plurality of various shapes. As illustrated in FIG. 2, the base 40 is circular and has the same diameter as the lowest tier 14. In other embodiments such as illustrated in FIG. 4, the base 40 could have a telescoping base, wherein the upper part 52 of the base 40 that engages the lowest tier 14 is the same diameter as that end of the lowest tier 14. The lower part 54 of the base 40 which contacts the ground may have a wider diameter. Though not illustrated, the vertical shape of the base can be conical in shape or trapezoidal in shape. Additionally, as further illustrated in FIG. 5, though not necessarily required, the upper part 52 of the base 40 should have a shape, such as circular as illustrated in FIG. 3, to meet with the lowest tier's diameter; however, the bottom part 54 of the base 40 could be configured to form another shape, such as a square. By providing a wider lower end 54 of the base than the container 10, tie-down stakes 31 passing through the anti-circling channels 26 may not be needed. In another embodiment, illustrated in FIG. 4, the bottom of the base 40 may comprise miniature stakes, or spikes, cleats 60, extending from the base 40 and into the ground.

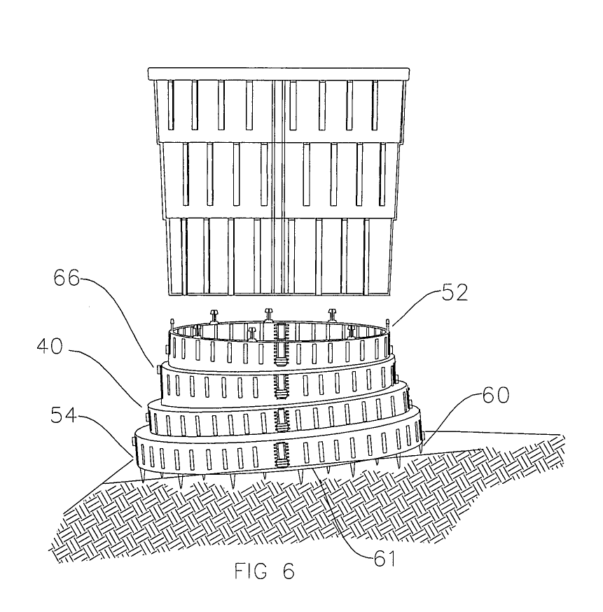

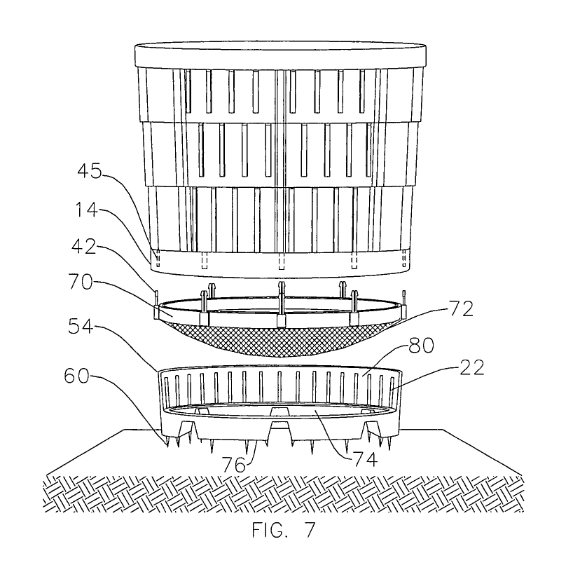

In another embodiment, illustrated in FIG. 6, the bottom 61 of the base 10 may be formed at an angle, so that if the container 10 is placed on an uneven surface, the container 10 would still be positioned in a more vertical direction, or level position, than it would be without a base 40 contoured as such. As further illustrated in FIG. 6, the base has an adjusting device 66 so that the base 40 is adjustable to create a plurality of angles to best accommodate the ground upon which the base 40 is placed.

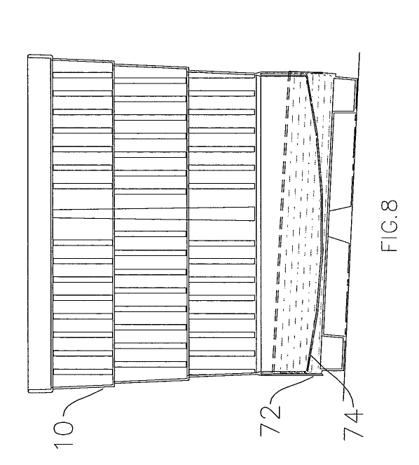

In a preferred embodiment, illustrated in FIGS. 7 and 8, the top or upper end 52 of the base 40 is wider, or has a diameter larger than the lowest tier 14. A flexible ring 70 with connection points 42, such as split arrowhead fasteners, extend from the flexible ring 70 to the openings 45 in the edge 32 of lowest tier 14. A leveling surface 72, such as a grid, is connected to the flexible ring 70 and has an angular shape. The inside bottom 74 of the base 40 is hollow with an angular shape, or receiving surface. In this embodiment, the sidewalls 80 of the base 40 has air pruning openings 22. As further illustrated in FIG. 7, cleats, or spikes 60 extend from the outside bottom 76 of the base 40 to the ground upon which the base 40 is placed. As illustrated in operation, in FIG. 8, when the container 10 is used on a surface with an incline or a decline, the container 10 is adjusted, in a preferred embodiment up to 30 degrees, where the container 10 is level with the horizon. Rotating the angular grid 72 that sits upon the angular receiving surface 74 makes the adjustment. Those skilled in the art will readily recognize that greater than 30 degrees is achievable if the diameter of the base 40 is enlarged to allow the container 10 more room to rotate, or be adjusted to a level state with the horizon.

In yet another preferred embodiment, not shown, the base 40 also includes openings 45 to allow a second base to be connected to the lower end 54 of the first base. The base may also comprise air-root pruning openings 22. Anti-circling channels 26 may also be provided. The anti-circling channels 26 may be lined up and extend from the lowest tier through the base 40, or the anti-circling channels 26 are not necessarily aligned with the anti-circling channels formed through the tiers 12, 13, 14.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

1. A plant growing apparatus, the apparatus comprising:
(a) a sidewall with an outer surface and an inner surface and having a plurality of tiers where each descending tier has a smaller diameter than the tier immediately above and wherein a ledge is formed in an inside of the sidewall where adjacent tiers meet;
(b) an anti-circling channel formed in the sidewall wherein the channel protrudes through the sidewall forming an indenture in the inner surface of the sidewall and a channel on the outer surface of the sidewall;
(c) a plurality of slots formed therethrough the sidewall;
(d) a detachable base that is connected to the sidewall.

2. The apparatus of claim 1 wherein the sidewall forms a geometric shape with an opening at a top edge of a top tier of the sidewall and a closed end at a lower edge the sidewall.

3. The apparatus of claim 2 wherein the closed end comprises a lip with at least one of a connection for securing the base and a drainage opening.

4. The apparatus of claim 1 wherein the sidewall forms a geometric shape with an opening at a top edge of a top tier of the sidewall and an opening at a lower edge of the sidewall.

5. The apparatus of claim 4 wherein a lip extends from the lower edge of the sidewall towards a center of the geometric shape with at least one of connection points for securing the base and drainage openings.

6. The apparatus of claim 1 further comprising an opening at a top end of the anti-circling channel disposed inside of the sidewall and an opening at a bottom of the anti-circling channel.

7. The apparatus of claim 6 further comprising a stake that fits through the opening at the top of the anti-circling channel, passes through the channel, and exits through the opening at the bottom.

8. The apparatus of claim 1 wherein the detachable base comprises a top end and a lower end wherein the lower end is broader than the top end.

9. The apparatus of claim 8 wherein the detachable base further comprises at least one of an anti-circling channel and slots formed therethrough the base.

10. The apparatus of claim 1 wherein the lower end of the base is contoured to conform to a ground surface allowing the apparatus to remain in a level position.

11. The apparatus of claim 10 further comprises a base that forms a gap between the lowest tier and the upper end of the base, an angular surface within a bottom of the lower end of the base and an angular grid that connects to the bottom of the lowest tier of the sidewall and rests upon the angular surface wherein the apparatus is adjustable to remain in a level position when the base is placed on an unleveled surface.

12. The apparatus of claim 10 wherein the base further comprises an adjustable lever to at least one of elevate and lower at least one of the base and a side of the base.

13. The apparatus of claim 1 further comprises cleats connected to a bottom of the base and extending in a downward direction from said base.

14. The apparatus of claim 1 wherein a shape of the top end of the base is different from a shape of the lower end of the base.

15. The apparatus of claim 1 further comprising a natural fiber-based insert inside of the sidewall.

16. The apparatus of claim 1 wherein the base comprises a bottom with openings formed therethrough.

17. A method of air pruning and controlling root growth in a plant, the method comprising:
(a) providing a container comprising a sidewall with a plurality of tiers where each descending tier has a smaller diameter than the tier immediately above;
(b) preventing a root from circling with an anti-circling channels extending upwardly along an inner surface of the sidewall;
(c) pruning a root with air entering through slots disposed therethrough the sidewall of the container; and
(d) elevating the container with a detachable base to allow air-root pruning to occur without interference from a ground covering.
(e) leveling an upper edge of the container to be nearly parallel with a horizon.

18. The method of claim 17 further comprising securing the container to the ground using a stake.

19. An improvement to a growing container having an anti-circling channel and air-root pruning openings, the improvement comprising:
a detachable base having a top end and a lower end wherein the base elevates the container.

20. The improvement of claim 19 further comprising the lower end of the base being configured to contour to an unleveled surface wherein the container remains in a level position.

21. The improvement of claim 19 wherein the shape of the top end of the base is different from the bottom end of the base.

22. The improvement of claim 19 wherein the base further comprises at least one of an anti-circling channel and air-root pruning openings.

23. The improvement of claim 19 further comprises a base having a wider width than a bottom of the container, an angular surface within a bottom of a lower end of the base and an angular grid that connects to the bottom the container and rests upon the angular surface wherein the container is adjustable to remain in a level position when the base is placed on an unleveled surface.

24. The apparatus of claim 19 wherein the base further comprises an adjustable lever to at least one of elevate and lower at least one of the base and a side of the base.
